(19) United States
(12) Patent Application Publication
(10) Pub. No.: US 2024/0238885 A1
(43) Pub. Date: Jul. 18, 2024

(54) GEAR GRINDING MACHINE AND METHOD

(71) Applicant: Klingelnberg AG, Zurich (CH)

(72) Inventor: Florian Kienzle, Moglingen (DE)

(21) Appl. No.: 18/413,977

(22) Filed: Jan. 16, 2024

(30) Foreign Application Priority Data
Jan. 16, 2023 (DE) 10 2023 100 894.3

(51) Int. Cl. B23F 1/02

(52) U.S. Cl. CPC B23F 1/02

(57) ABSTRACT

A gear grinding machine includes a spindle arrangement, having a rotationally drivable tool spindle for accommodating a tool, having a spindle bearing for mounting the tool spindle in a housing, having a temperature sensor, wherein the temperature sensor is assigned to a bearing outer ring of the spindle bearing of the tool spindle and is adapted to measure a bearing outer ring temperature of the bearing outer ring, having a control device for controlling a grinding process of a toothing to be ground and/or for controlling a dressing of the tool. The control device is adapted to perform a temperature compensation based on a measured bearing outer ring temperature of the bearing outer ring compared to a reference temperature, wherein a temperature-induced axial displacement of the tool spindle is compensated.

### CROSS-REFERENCE TO RELATED APPLICATIONS

This application claims the benefit of German patent application 10 2023 100 894.3, filed on 16 Jan. 2023, the disclosure of which is incorporated herein by reference in its entirety.

### TECHNICAL FIELD

The present disclosure relates to a gear grinding machine, a method for dressing a grinding tool and a method for grinding a toothing.

### BACKGROUND

When grinding gears with dressable grinding tools, it is necessary to dress a respective grinding tool used for grinding toothings from time to time in order to restore the intended target geometry of the profile of the grinding tool. Such a grinding tool is held within the gear grinding machine on a tool spindle, which can also be referred to as a grinding spindle. The tool spindle is used to drive the tool in rotation and can be moved in a CNC-controlled manner relative to the toothing to be ground in order to execute the grinding kinematics.

The dressing of a grinding tool usually takes place within the gear grinding machine, wherein the grinding tool remains in its position clamped on the grinding spindle during dressing. The gear grinding machine in question therefore has a dressing tool that can be used to dress the grinding tool within the gear grinding machine. Dressing is also automated, i.e. CNC-controlled.

The tool spindle cools down between grinding and dressing. For example, the grinding spindle may be 1 pprox. 10° C. cooler during dressing than in the warmed-up, stationary state during gear grinding. Due to this temperature difference, there is an axial displacement of the grinding spindle and consequently an axial displacement of the grinding tool held on this grinding spindle, such as a grinding worm.

During dressing, errors occur in the dressed grinding tool geometry, such as a dressed grinding worm geometry, as a result of the temperature-induced displacement. Depending on the dressing strategy, it can therefore occur that a pitch of a grinding worm is not in the correct position when viewed in the axial direction or that neighboring gears of the grinding worm are not positioned correctly relative to each other. Furthermore, the profile of an individual pitch itself may be incorrect, especially if the dressing is performed on a single flank with a correspondingly long dressing time.

In addition to the dressing challenges described above, the initial grinding of components with a cold grinding spindle after dressing can also lead to temperature-induced deviations. Here, for example, the temperature-induced axial displacement of the grinding tool can result in a strong one-sided removal and flanks that are not completely ground.

### SUMMARY

Against this background, the present disclosure is based on the technical problem of providing a gear grinding machine and methods for grinding a toothing and for dressing a grinding tool, which do not have the disadvantages described above, or at least to a lesser extent, and in particular enable reliable and repeatable dressing and grinding.

The technical problem described above is solved in each case with the features of the independent claims. Further embodiments of the disclosure result from the dependent claims and the following description.

According to the disclosure, a gear grinding machine is provided, having a spindle arrangement, having a rotationally drivable tool spindle for accommodating a tool, having a spindle bearing for mounting the tool spindle in a housing, having a temperature sensor, wherein the temperature sensor is assigned to a bearing outer ring of the spindle bearing of the tool spindle and is adapted to measure a bearing outer ring temperature of the bearing outer ring, having a control device for controlling a grinding process of a toothing to be ground and/or for controlling a dressing of the tool, wherein the control device is adapted to perform a temperature compensation on the basis of a measured bearing outer ring temperature of the bearing outer ring with respect to a reference temperature, wherein a temperature-induced axial displacement of the tool spindle is compensated.

Surprisingly, investigations by the applicant have shown that an axial displacement of the tool spindle can be compensated for particularly well if the temperature compensation is based on the bearing outer ring temperature of the bearing outer ring of the spindle bearing. It has been shown that temperature changes in the tool spindle can be measured quickly and reliably in the area of the bearing outer ring. In this way, a reliable and cost-effective temperature compensation can be specified to take into account temperature-induced axial displacements of the tool spindle.

For example, a machine bed temperature of a machine bed of the gear grinding machine can be used as a reference temperature. The machine bed temperature can, for example, be recorded using another temperature sensor, which can be located in the area of the machine bed.

Alternatively, an ambient temperature of an environment surrounding the gear grinding machine can be used as a reference temperature. This can be a hall temperature of a machine hall, for example. It may be provided that the ambient temperature of the surroundings is recorded by means of a further temperature sensor of the gear grinding machine. Alternatively or additionally, it may be provided that the ambient temperature can be detected by means of an external temperature sensor and transmitted wirelessly or by cable to the control device of the gear grinding machine.

The tool can be a dressable grinding tool.

The tool can be a dressable grinding worm.

The tool can be a dressable grinding wheel.

It may be provided that the temperature compensation is carried out according to the following rule: (T₁−T₂)*K=Δy, with T₁ as the bearing outer ring temperature in ° C., with T₂ as a reference temperature in ° C., with K as a compensation factor in μm/° C., and with Δy as the axial compensation value for compensating the axial displacement of the tool spindle.

It may be provided that the control device is adapted to offset the axial compensation value Δy with a position setpoint value Y_{SOLL}, wherein the position setpoint value Y_{SOLL} defines an axial position of the tool along a tool spindle axis of the tool spindle.

For example, the control device can be adapted to subtract the axial compensation value Δy from the position setpoint value Y_{SOLL}.

Compensation can be made, for example, against a reference temperature of 20° C. This means that for this example, a temperature-induced axial displacement of the tool spindle for a bearing outer ring temperature of 20° C. is zero or is defined as zero. If the bearing outer ring temperature corresponds to the reference temperature, no compensation of the axial position of the tool spindle is therefore required, as the specified position can be achieved exactly according to the position setpoint value Y_{SOLL} and is not distorted due to temperature.

For the following calculation example, the reference temperature is 20° C. and the bearing outer ring temperature is 30° C. Measurements can be used to determine that this temperature difference of 10° C. results in an axial displacement of the tool spindle of 30 μm. If a linear relationship between the temperature difference and the axial displacement can be assumed, which the above formula presupposes and which can be verified by further measurements for other temperature differences, the compensation factor of 3 μm/° C. can be determined from this.

Conversely, this determined compensation factor of 3 μm/° C. therefore results in a compensation value of 30 μm for the bearing outer ring temperature of 30° C., which precisely compensates for the axial displacement previously measured in tests. In other words, the tool held on the tool spindle is displaced by 30 μm in the axial direction as a result of the temperature difference to the reference temperature, wherein this axial displacement is compensated for by subtracting the compensation value, which is also 30 μm, from the position setpoint value Y_{SOLL}. This ensures that the tool is always in one and the same axial position for a specified position setpoint value Y_{SOLL} both at a bearing outer ring temperature of 20° C. and at a bearing outer ring temperature of 30° C. This would result in a compensation value of 60 μm for a bearing outer ring temperature of 40° C. and a compensation value of 120 μm for a bearing outer ring temperature of 60° C.

It can be seen that the position setpoint value Y_{SOLL} can be positive or negative, depending on the definition of the axis direction and the zero point of the axis. It is understood that the compensation for a negative position setpoint value must be carried out accordingly, taking into account the sign. If, for example, a position Y_{SOLL} 100 mm is to be approached, the compensation value Δy would have to be added (Y_{SOLL,komp}=−100 mm+0.030 mm) in order to compensate for the temperature-induced expansion of the spindle and to achieve a position Y_{SOLL,komp}=−100 mm mm exactly, as subtraction (Y_{SOLL,komp}=−100 mm−0.030 mm) would double the error instead of compensating for it. Y_{SOLL,komp} denotes the compensated position setpoint value here.

Temperature compensation can be carried out in a similar way based on a temperature of the stationary state of a grinding process. For example, it could be specified that the compensation value for a temperature of the steady state of, for example, 50° C. or 60° C. is zero and that deviations from this reference temperature of the steady state are compensated for by temperature compensation. While a minimum temperature of the tool spindle is assumed as a reference when using the temperature of the environment, the steady state would set a maximum temperature of the tool spindle as a reference. Accordingly, compensation values for the steady state reference could be added to a position setpoint value to ensure that the tool is at the same position for a set position setpoint value for any operating temperature.

In other words, temperature compensation based on a minimum temperature or an ambient temperature compensates for temperature-induced expansions of the tool spindle, while compensation based on the stationary state of the grinding process compensates for temperature-induced shortening of the tool spindle in the axial direction. As a result, both procedures are identical.

The reference temperature can therefore theoretically be selected at will as long as the relationship between a temperature change and a change in length of the tool spindle is known, e.g. linear, for the relevant operating range or for the temperature window in which the gear grinding machine is operated. If, for example, the relationship between a change in temperature and a change in length is not linear for a relevant temperature range as assumed here, a compensation function can be adapted accordingly by formula in order to map the real conditions as accurately as possible.

The control device can be adapted to perform temperature compensation when dressing a grinding tool held on the tool spindle. In particular, the grinding tool can be a grinding worm. In particular, the grinding worm can be a single-start grinding worm or a multi-start grinding worm. Alternatively, the grinding tool can be a grinding wheel.

The control device can be adapted to carry out temperature compensation when grinding a workpiece, wherein the grinding is carried out by means of a grinding tool held on the workpiece spindle. In particular, the grinding tool can be a grinding worm. In particular, the grinding worm can be a single-start grinding worm or a multi-start grinding worm. Alternatively, the grinding tool can be a grinding wheel.

For both grinding and dressing, temperature compensation ensures correct relative positioning in the axial direction, taking into account temperature-induced changes in length or displacement of the grinding spindle. It is irrelevant whether the compensation value Δy is offset against the position setpoint value Ysou of the tool and/or is taken into account in the kinematics of the workpiece or the dresser. The only decisive factor is the correct axial position relative to each other.

It may be provided that the temperature compensation is based on a position setpoint value of the workpiece or the dresser and/or the tool.

Alternatively or additionally, the temperature compensation can be carried out by adjusting the machine kinematics of one or more machine axes of the gear grinding machine.

A distance can be formed between the temperature sensor and the bearing outer ring. In particular, the distance can be selected in such a way that the temperature of the bearing outer ring can still be reliably detected. The distance can ensure that any vibrations of the bearing outer ring are not transmitted to the temperature sensor and that the temperature sensor is not damaged by displacements of the bearing outer ring.

It may be provided that a material is arranged between the temperature sensor and the bearing outer ring that promotes heat conduction between the temperature sensor and the bearing outer ring. In this way, it can be ensured that a temperature change in the bearing outer ring is quickly detected by the temperature sensor.

According to alternative embodiments, it may be provided that the temperature sensor is in contact with the bearing outer ring without a gap. In this way, any change in temperature of the bearing outer ring can be detected directly.

Two or more temperature sensors can be provided to detect the temperature of the bearing outer ring. This allows redundancies to be created. Alternatively or additionally, bearing outer ring temperatures of two or more bearings of a spindle bearing arrangement can be recorded. The bearing outer ring temperature can be specified as the mean value of the measured values from two temperature sensors or several temperature sensors.

The control device can be adapted to only update a compensation value of the temperature compensation when no machining is taking place, in particular when no grinding or dressing is taking place. Otherwise, the temperature compensation could possibly interfere with process kinematics during grinding or dressing, as, for example, a position setpoint value would be constantly tracked as a result of temperature fluctuations during machining.

According to the disclosure, a method is provided comprising the following method steps: grinding a toothing by means of a gear grinding machine, wherein the gear grinding machine is designed in accordance with the disclosure; performing a temperature compensation on the basis of a measured bearing outer ring temperature of the bearing outer ring, wherein a temperature-induced axial displacement of the tool spindle is compensated during grinding.

A method according to the disclosure is further disclosed, comprising the method steps of: Dressing a grinding tool by means of a gear grinding machine, wherein the gear grinding machine is designed in accordance with the disclosure; performing a temperature compensation on the basis of a measured bearing outer ring temperature of the bearing outer ring, wherein a temperature-induced axial displacement of the tool spindle is compensated during dressing.

All the method steps discussed above with reference to the gear grinding machine can be method steps of the methods according to the disclosure.

### BRIEF DESCRIPTION OF THE DRAWINGS

The disclosure is described in more detail below with reference to a drawing illustrating exemplary embodiments, wherein the drawings show schematically in each case:

FIG. 1 shows a section of a gear grinding machine according to the disclosure;

FIG. 2 shows the gear grinding machine according to the disclosure with a toothing;

FIG. 3 shows the gear grinding machine according to the disclosure during dressing;

FIG. 4 shows temperature-induced errors of a flank line and a compensated flank line;

FIG. 5 shows a flow chart of a method according to the disclosure;

FIG. 6 shows a further flow chart of a method according to the disclosure; and

FIG. 7 shows a gear grinding machine according to the disclosure.

### DETAILED DESCRIPTION OF THE DRAWINGS

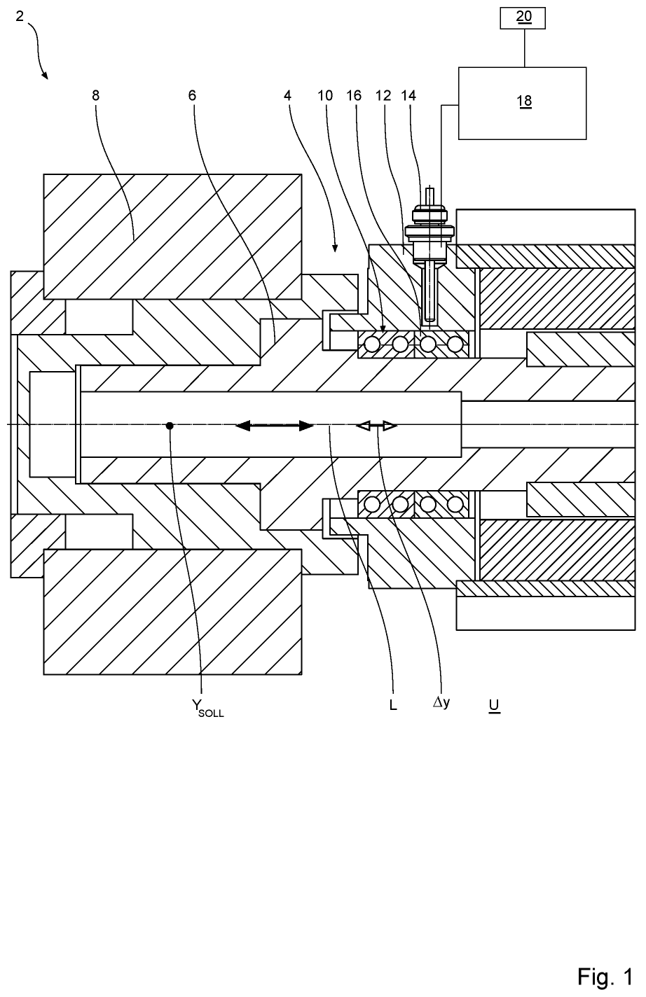

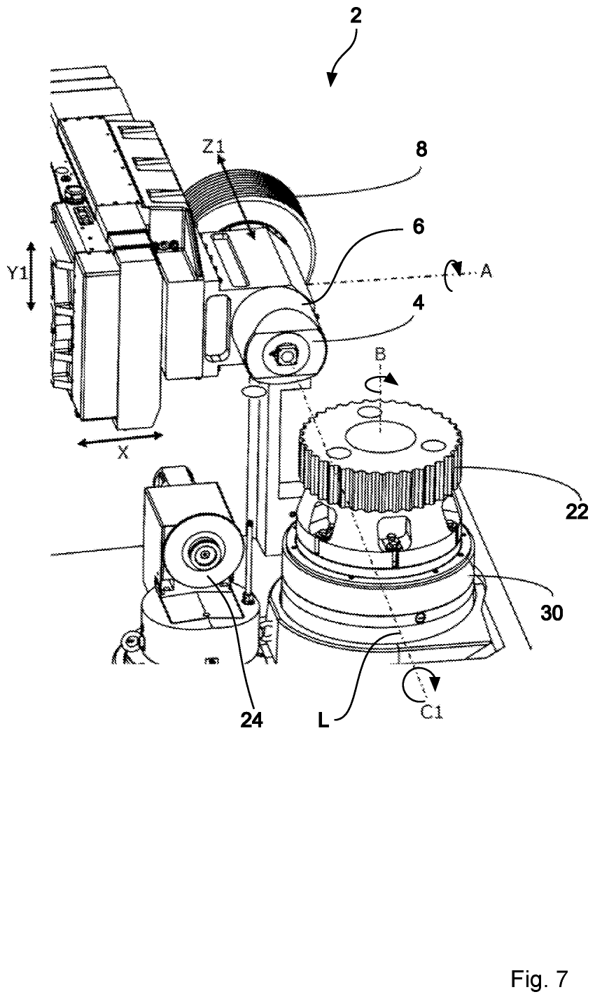

FIG. 1 schematically shows a section of a gear grinding machine 2 according to the disclosure as shown in FIG. 7. This is a CNC-controlled gear grinding machine 2, wherein for simplification of the following explanations, only the area of this gear grinding machine 2 relevant to the disclosure is shown in FIG. 1.

The gear grinding machine 2 has a spindle arrangement 4.

The spindle arrangement 4 has a rotationally drivable tool spindle 6 for accommodating a tool 8. In the present case, the tool 8 is a grinding worm, which is only shown schematically.

The spindle arrangement 4 has a spindle bearing 10 for mounting the tool spindle 6 in a housing 12.

The gear grinding machine 2 has linear axes X, Y1, Z1 for performing translatory relative movements (FIG. 7). The gear grinding machine 2 has a tool rotation axis C1 for tool rotation, a tool pivot axis A for pivoting the tool 8 and a workpiece rotation axis B for rotating a workpiece 22, which is seated on a turntable 30. A dresser 24 can also be moved relative to the workpiece 22 to carry out dressing movements.

The spindle arrangement 4 has a temperature sensor 14 (FIG. 1).

The temperature sensor 14 is assigned to a bearing outer ring 16 of the spindle bearing arrangement 10. The temperature sensor 14 is adapted to measure a bearing outer ring temperature of the bearing outer ring 16.

The gear grinding machine 2 also has a control device 18 which is used to control a grinding process of a toothing to be ground. The control device 18 is adapted to perform a temperature compensation using a measured bearing outer ring temperature of the bearing outer ring 16 compared to a reference temperature, wherein a temperature-induced axial displacement of the tool spindle 6 is compensated.

The axial displacement relates to a temperature-induced expansion and a temperature-induced shortening along a longitudinal axis L of the tool spindle 6, as indicated by the double arrow on the longitudinal axis L. The longitudinal axis L is oriented parallel to the axis Z1.

In the present case, the reference temperature is an ambient temperature of an environment U of the gear grinding machine 2. The ambient temperature is detected in the present case by means of a further temperature sensor 20, which is connected to the control device 18.

According to alternative embodiments, it can be provided that a machine bed temperature of a machine bed of the gear grinding machine 2 is detected by means of such a further temperature sensor instead of the ambient temperature.

Temperature compensation is carried out in accordance with the following regulation:

$${( {T}_{1} - {T}_{2} )}^{*} K = Δ y$$

with T₁ as the bearing outer ring temperature in ° C., with T₂ as the reference temperature in ° C., with K as a compensation factor in μm/° C., and with Δy as the axial compensation value Δy to compensate for the axial displacement of the tool spindle 6.

The control device 18 is set up to subtract the axial compensation value Δy from a position setpoint value Y_{SOLL}, wherein the position setpoint value Y_{SOLL} defines an axial position of the tool 8 along the tool spindle axis L of the tool spindle 6. In this case, the position setpoint value Y_{SOLL} defines the current specified setpoint position of the tool 8 along the tool spindle axis L.

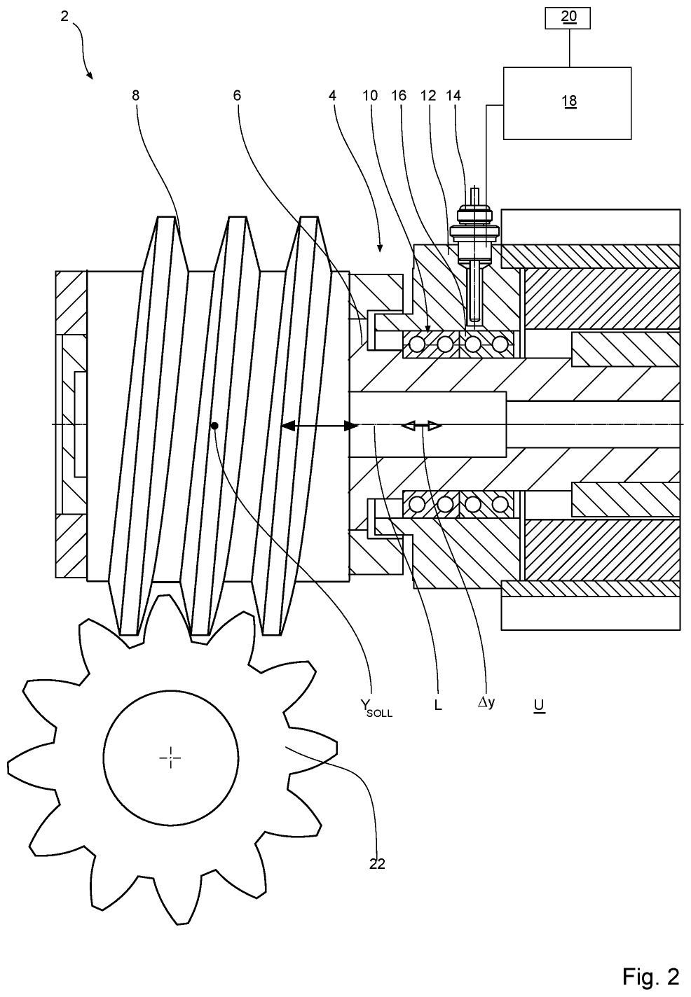

In the present case, the control device 18 is adapted to perform the temperature compensation when grinding a workpiece 22 by means of the grinding tool 8 held on the tool spindle 6, as shown in FIG. 2 as an example. In FIG. 2, the tool 8 is now shown in a highly simplified and schematic form as a grinding worm. The workpiece 22 is shown as an example of a spur gear with straight teeth.

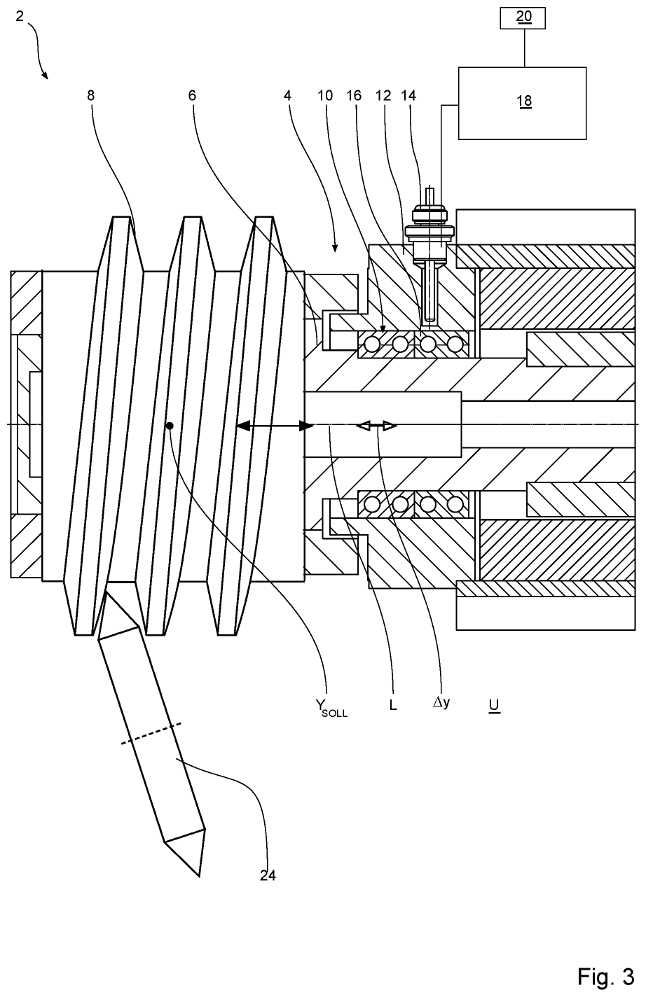

The control device 18 is also adapted in the present case to perform temperature compensation during dressing of the tool 8 by means of the dresser 22, as shown in FIG. 3 as an example.

For both grinding and dressing, the temperature compensation ensures correct relative positioning in the axial direction, taking into account temperature-induced changes in length along the longitudinal axis L. It is irrelevant whether the compensation value Δy is offset against the position setpoint value Y_{SOLL} of the tool 8 or is taken into account in the kinematics of the workpiece 22 or the dresser 24. The only decisive factor is the correct axial position relative to each other.

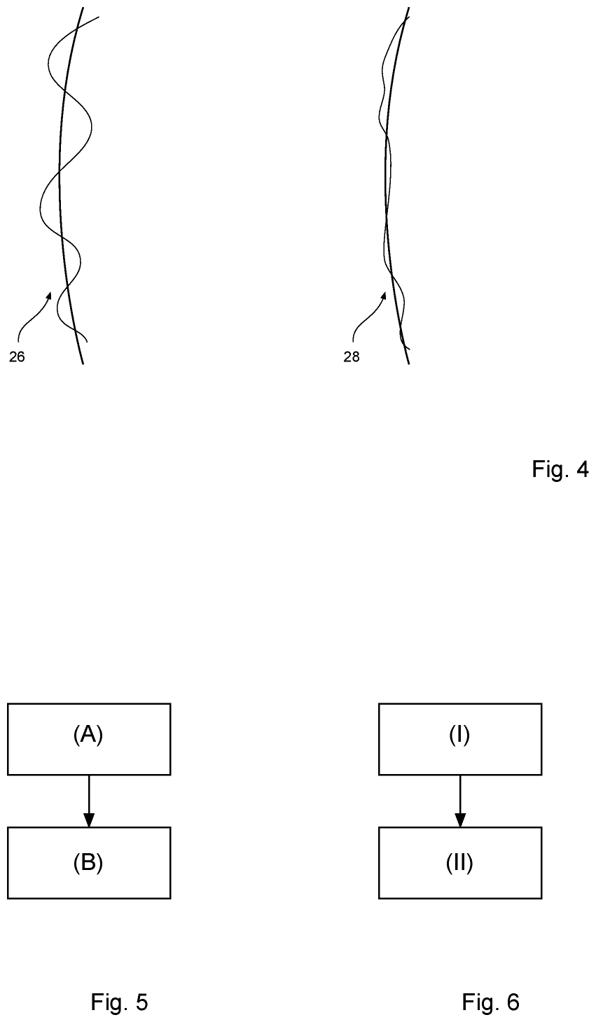

FIG. 4 shows a measurement record of a flank line 26 without compensation. The measured flank line 26 has a waviness whose period length corresponds to the product of the axial feed multiplied by the number of passes of the tool 8. The waviness results from a lack of temperature compensation during dressing, which leads to a pitch to pitch error of the tool 8. The picture on the right shows a measurement record of a flank line 28 compensated according to the disclosure, for which the waviness could be significantly reduced.

According to the disclosure, a method is provided, comprising the method steps of: (A) determining a compensation value for compensating the axial displacement of the tool spindle; (B) grinding a toothing by means of the gear grinding machine 2 and performing a temperature compensation on the basis of a measured bearing outer ring temperature of the bearing outer ring 16, wherein a temperature-induced axial displacement of the tool spindle 6 is compensated during grinding (FIG. 5).

According to the disclosure, a method is provided, comprising the method steps of: (I) determining a compensation value for compensating the axial displacement of the tool spindle 6; (II) dressing the grinding tool 8 by means of the gear grinding machine 2 and performing a temperature compensation using a measured bearing outer ring temperature of the bearing outer ring 16, wherein a temperature-induced axial displacement of the tool spindle 6 is compensated during dressing (FIG. 6).

1. A gear grinding machine comprising:
a spindle arrangement,
having a rotationally drivable tool spindle for accommodating a tool,
having a spindle bearing for mounting the tool spindle in a housing,
having a temperature sensor,
wherein the temperature sensor is assigned to a bearing outer ring of the spindle bearing of the tool spindle and is adapted to measure a bearing outer ring temperature of the bearing outer ring,
having a control device for controlling a grinding process of a toothing to be ground and/or for controlling a dressing of the tool, wherein the control device is adapted
to perform a temperature compensation based on a measured bearing outer ring temperature of the bearing outer ring compared to a reference temperature,
wherein a temperature induced axial displacement of the tool spindle is compensated.

2. The gear grinding machine according to claim 1,
wherein
the reference temperature is a machine bed temperature of a machine bed of the gear grinding machine, or
the reference temperature is an ambient temperature of an environment (U) of the gear grinding machine.

3. The gear grinding machine according to claim 1,
wherein
temperature compensation is carried out in accordance with the following regulation:
$${( {T}_{1} - {T}_{2} )}^{*} K = □ y ,$$
with T₁ as the bearing outer ring temperature in ° C.,
with T₂ as reference temperature in ° C.,
with K as a compensation factor in μm/° C., and
with □y as the axial compensation value to compensate for the axial displacement of the tool spindle.

4. The gear grinding machine according to claim 3,
wherein
the control device is adapted to offset the axial compensation value □y with a position setpoint value Y_{SOLL},
wherein the position setpoint value Y_{SOLL} defines an axial position of the tool along a tool spindle axis of the tool spindle.

5. The gear grinding machine according to claim 1, wherein
the control device is adapted to carry out the temperature compensation during dressing of a grinding tool held on the tool spindle, wherein the grinding tool is in particular a grinding worm.

6. The gear grinding machine according to claim 1, wherein
the control device is adapted to carry out the temperature compensation during the grinding of a workpiece by means of a grinding tool held on the tool spindle, wherein the grinding tool is in particular a grinding worm.

7. The gear grinding machine according to claim 1, wherein
a gap is formed between the temperature sensor and the bearing outer ring.

8. The gear grinding machine according to claim 1, wherein
the control device is adapted to perform an update of a compensation value (Δy) of the temperature compensation only when no machining takes place, in particular no grinding or no dressing takes place.

9. A method including the following:
grinding a toothing by means of a gear grinding machine, wherein the gear grinding machine is designed according to claim 1, and
performing a temperature compensation based on a measured bearing outer ring temperature of the bearing outer ring, wherein a temperature induced axial displacement of the tool spindle is compensated during grinding.

10. A method including the following steps:
dressing a grinding tool by means of a gear grinding machine, wherein the gear grinding machine is designed according to claim 1, and
performing a temperature compensation based on a measured bearing outer ring temperature of the bearing outer ring, wherein a temperature induced axial displacement of the tool spindle is compensated during dressing.
